(19) United States
(12) Patent Application Publication
(10) Pub. No.: US 2022/0207220 A1
(43) Pub. Date: Jun. 30, 2022

(54) APPARATUSES AND METHODS FOR BATTLEFLOW ANALYSIS AND DECISION SUPPORT

(71) Applicant: Purdue Research Foundation, West Lafayette, IN (US)

(72) Inventors: Sorin Matei, Chicago, IL (US); Jonathan Poggie, West Lafayette, IN (US); Matthew Konkoly, Carmel, IN (US); Robert Kirchubel, Riverview, FL (US)

(21) Appl. No.: 17/449,447

(22) Filed: Sep. 29, 2021

Related U.S. Application Data
(60) Provisional application No. 63/084,901, filed on Sep. 29, 2020.

(51) Int. Cl. G06F 30/28; G06F 30/12

(52) U.S. Cl. CPC G06F 30/28; G06F 2111/08; G06F 30/12

(57) ABSTRACT

Apparatuses and methods for simulating the interaction of units, such as military units interacting on the battlefield, are disclosed. Embodiments utilize equations representing conservation of individuals and/or the ability to track the identity of unit components (“sub-units”). Further embodiments utilize fluid flow models for calculating personnel movement and/or formulating results as a probability distribution of where personnel are likely to be found after one or more time periods. Still further embodiments use terrain, overlays to the terrain (impediments) and/or casualties to influence group movement. Embodiments present information as contour lines of equal potential for locating personnel and/or casualties. Still further embodiments allow simulations to be run while changing various parameters to give predictive models of what is likely to occur.

This application claims the benefit of U.S. Provisional Application No. 63/084,901, filed Sep. 29, 2020, the entirety of which are hereby incorporated herein by reference.

### FIELD

Embodiments of this disclosure relate to warfare simulations and warfare simulators that assist in training military personnel as well as providing rapid feedback to assist warfighters on the battlefield.

### BACKGROUND

Military simulations typically use discrete agents for analyzing warfare scenarios and tactics. These discrete agents typically represent individuals or individual units, and each discrete agent is programmed to move or interact with their environment in specific manners. Existing models for determining how these discrete agents move or interact with their environment are based on static, discrete agent thinking that began during the World War I era in the early 20^{th} century. However, it was realized by the inventors of the current disclosure that problems exist with this discrete agent modeling and that improvements in warfare simulations are needed. Certain preferred features of the present disclosure address these and other needs and provide other important advantages.

### SUMMARY

Electronic tracking of vehicles and individual soldiers provides a very large quantity of real-time information to the higher echelons; however, the sheer quantity of data may thicken the fog of war and make decisions more difficult and time consuming.

One alternative to computationally expensive discrete agent models is fluid-like models, but the inventors of the present disclosure realized that existing models of this type also have many deficiencies. For example, it was realized by the inventors of the present disclosure that many existing flow models overemphasize the fluid and/or static aspects of their formulations and lack an infrastructure to represent, for instance, the infantry squares of the Napoleonic era as fluid units without any considerations for discrete agents. The inventors of the present disclosure also realized that new approaches to operational analytics could bring a new perspective on data, such as preserving unity identity without sacrificing representation of their fluidity, simplifying data sets to what is necessary, modelling what is needed, and suggesting possible courses of action.

Embodiments of the present disclosure provide an improved apparatuses and Methods for Battleflow Simulation and Decision Support. Example embodiments include models (such as, continuous flow models) of the behavior of units, such as military personnel (such as, infantry) during military conflict.

Embodiments of the present disclosure include models for modeling movement of groups, such as groups of military personnel, in which a conflict is represented by the flow of virtual fluids governed by a set of rules that may be consistent, at least in an averaged sense, with those governing a corresponding discrete agent model. In simplistic situations, the overall movement can be similar for the two approaches. However, in more complex situations the two approaches vary considerably.

Some embodiments include one or more crowd flow models (such as those based on conservation of individuals), empirical data (such as on walking speed under varying crowd density and/or surface inclinations) and an attrition model to account for casualties (such as variations of a Lanchester attrition model). Various embodiments incorporate close-in combat and/or ranged fire into the model.

Some embodiments include an additional variable to track the identity of a subunit within an overall unit, which can have benefits in implementing relative movements of units and/or unit orientations.

Various embodiments include models for how ground troops adjust their walking behavior to the terrain.

Further embodiments include numerical solutions of multi-group crowd flow equations with an attrition source. Still further embodiments employ conventional implicit, second-order, upwind methods for convection-diffusion equations in the calculations.

Embodiments of the present disclosure produce results that realistically depict infantry combat. For example, embodiments reflect the tendencies for advancing forces to pile up in the rear and stretch out in the front, and for interacting armies to form linear fronts. Example embodiments illustrate unit reorientation and one or more breakpoints.

Still further embodiments model battlefield dynamics as a continuous flow that provides strategic decision makers with a more intuitive understanding of the momentum of a conflict and/or reduces the quantity of information that a human observer needs to assess the flow of battle.

Embodiments include the modelling and simulation of military conflicts that combine a continuous crowd flow model and subunit identity tracking with an extension of the Lanchester attrition model to continuous variables.

Further embodiments include behavioral models for how units adapt their motion to the terrain. Still further embodiments include the use of subunit identity tracking and/or adaptation to terrain. Yet additional embodiments model battlefield dynamics as a continuous flow, which may provide decision makers with a more intuitive understanding of the momentum of a conflict.

Embodiments of the present disclosure utilize a continuous flow model for simulating interactions between different groups, such as simulation of military conflict. Embodiments utilize the concept of continuous groups (such as pedestrian or vehicular flow), which is also the basis for more complex models that consider variability in transportation, speed, and clumping of forces in and around vehicles.

Some embodiments extend the definition of the pedestrian goal potential to allow different destinations for different subunits. In still further embodiments units can pivot and/or reorient as well as flow. Still further embodiments include models of how ground troops adapt their behavior to the terrain.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 depicts different models for walking speed implemented in various embodiments of the present disclosure.

FIG. 2 is a graphical representation of relative motion and orientation utilized in embodiments of the present disclosure.

FIG. 3 is a graphical representation of a ranged fire model utilized in embodiments of the present disclosure.

FIG. 4 is a depiction of the density of two groups at different times during a simulation according to at least one embodiment of the present disclosure.

FIG. 5 is a depiction of the casualties of the groups depicted in FIG. 4 according to at least one embodiment of the present disclosure.

FIG. 6 is a depiction of the density of two groups at different times during a simulation according to at least one other embodiment of the present disclosure.

FIG. 7 is a depiction of the casualties of the groups depicted in FIG. 6 according to at least one embodiment of the present disclosure.

FIG. 8 is a depiction of the density of two groups at different times during a simulation according to at least one further embodiment of the present disclosure.

FIG. 9 is a depiction of the casualties of the groups depicted in FIG. 8 according to at least one embodiment of the present disclosure.

FIG. 10 is a depiction of the density of two groups at different times during a simulation according to at least one additional embodiment of the present disclosure.

FIG. 11 is a depiction of the casualties of the groups depicted in FIG. 10 according to at least one embodiment of the present disclosure.

FIG. 12 is a depiction of the density of two groups at different times during a simulation according to at least one further embodiment of the present disclosure.

FIG. 13 is a depiction of the casualties of the groups depicted in FIG. 12 according to at least one embodiment of the present disclosure.

FIG. 14. is a flow chart depicting processes according to one or more embodiments of the present disclosure.

FIG. 15 illustrates an example system according to one embodiment of the present disclosure.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

The information-rich battlefield of today provides streams of real-time data, resulting in tremendous amounts of information available to military commanders. However, such a large amount of information results in heavy computational requirements that are unable to provide information to military commanders in a timely fashion. Embodiments of the present disclosure provide dynamic, probabilistic flow models that simplify the data and computational burdens without sacrificing crucial information. Still further embodiments suggest strong and valid predictions regarding battle movement, effective firepower, variable lethality, attrition, breakpoints, and the winnability of each operation.

Embodiments of the present disclosure include realistic war game simulations and battle flow modelling. Multiple units from each side of a conflict can be positioned on the battlefield, each with independent orders for positioning and orientation. Decision-making logic, such as that based on total casualties and/or tactical goals, can be assigned to each unit.

Embodiments include simulations utilizing numerical solutions of a multi-group crowd flow equation with an attrition source term. Conventional, second-order, implicit upwind methods for convection-diffusion equations are employed in some embodiments.

Embodiments of the present disclosure produce behavior that depicts realistic interactions between groups, such as interactions during infantry combat. A dense advancing force tends to pile up in the rear and stretch out in the front, and interacting armies tend to spontaneously form a linear front. Reorientation of the groups and a breakpoints are included in various embodiments. Ranged fire may be included in some embodiments, and has the expected effect of keeping the enemy at bay. At least two optional calculations may be used in some embodiments for simulating the effect of terrain on group (infantry) behavior.

Embodiments model battlefield dynamics as a continuous flow, which can have applications in training decision makers (such as by running scenarios in a classroom environment) and assisting decision makers in understanding probabilistic outcomes in actual combat situations. Embodiments include a more intuitive understanding of the movement and momentum of a conflict to assist decision makers. For example, in embodiments with a continuous density, it is easier to assess collective actions, reducing the quantity of information that a human observer needs to assess the flow of battle. Embodiments of the present disclosure offer improvements in simulations that can help address some of the criticisms of war gaming that have been expressed by western military leaders in recent years.

In contrast with modelling military operations as war game style simulations using discrete agents, embodiments of the present disclosure include modeling in which a conflict is represented by the flow of virtual fluids that are governed by a set of rules. While the rules can result in the overall movement in some simple scenarios being similar to movement resulting from discrete agent models, the rules are much more robust and take numerous variables into account allowing embodiments of the present disclosure to provide simulations and predictions that better reflect and predict real world situations.

In at least one embodiment, a continuous density of individuals (in other words, the probability of finding an individual at a particular location at a particular time) is computed and used to “track” how the unit moves and interacts.

A virtual fluid approach can represent the motion of any large group of discrete entities and can capture the dynamics of unit motion in way that is not possible when aggregating discrete agents as is currently being used.

TABLE 1
Nomenclature relating fluid dynamic terms to military terms

| Fluid Dynamics | Military Simulation |
|---|---|
| Fluid flow | Battle flow |
| Species (e.g., nitrogen gas) | Unit (e.g., an army) |
| Fluid particle (small group of | Subunit (small group of |
| molecules) | individuals) |
| Molecule (e.g., nitrogen molecule) | Individual (e.g., one solider, |
| | one vehicle) |

To assist in the understanding of embodiments of the present disclosure, Table 1 correlates the vocabulary of fluid dynamics with the corresponding terms in a crowd-flow based military simulation. In both the fluid dynamics and military simulation cases, the largest-scale concept is a flow of a real or virtual fluid that can be characterized by a state (for instance, density and velocity) at each point in space. A real flow model in fluid dynamics may consist of different chemical species, such as nitrogen and oxygen. For a military battle flow model or simulation, the corresponding term is a unit; which can range in scale from an army to a squad depending on the simulation. The next concept in fluid dynamics is a fluid particle, consisting of many molecules, but very small compared to the overall extent of the flow. In our military simulations, we will call this a subunit, and envision it to consist of a small group of individuals. The smallest division in the hierarchy is a molecule in fluid dynamics, and an individual soldier or vehicle in a military simulation.

For a continuous flow model to reasonably represent reality, many individuals must interact to make up the flow. It could be argued that the density of individuals in modern infantry combat is too low to represent the aggregate as a fluid. However, interpreting density as a probabilistic expectation value rather than as a deterministic figure, the crowd flow model can appropriately be applied to dispersed groups such as individuals in modern infantry combat.

Taking a continuous density of individuals as the predicted quantity as done in embodiments of the present disclosure has a number of advantages over tracking units as discrete war game pieces. Using continuous density facilitates a probabilistic interpretation of predictions, making it easier to assess collective actions and reducing the quantity of information that a human observer needs to assess the flow of battle. A continuous density approach can also be more computationally efficient, enabling realism without tracking large numbers (for example, thousands) of discrete agents. For example, using discrete agents to simulate a company of soldiers (approximately 150 soldiers) or a larger brigade (approximately 4000 soldiers) and track a handful of soldiers who are slow is extremely costly computationally. Finally, representing a military force as a discrete agent (such as a game counter) is inherently unrealistic since units can mix, break-up, or reform, and these possibilities cannot be addressed when defining groups of individuals as discrete agents. Representing a military force in a continuous density approach tends to be much more realistic since this approach allows for any groups to mix, break up, and reform.

In embodiments of the present disclosure, the density of individual members (for example, foot soldiers or vehicles) can be tracked as a conserved quantity, and their movement can depend on goals and local conditions. Examples of the goals can be particular targets to attack, certain destinations to move toward, and/or restorative commands to reform the individual members into the proper formations or orientations. Local conditions can tend to disrupt the flow of the individual members and can represent, for example, terrain (such as hills, valleys, flowing water and/or stationary water), obstacles (such as buildings, barricades, fences, and/or concertina/razor wire), improvements (such as paved surfaces), vegetation (such as trees, shrubs, and/or hedgerow vegetation), ground conditions (such as wet or hard ground), member fatigue, and/or interactions between members (such as the tendency of a slower/faster member to impact the movements of nearby members, which can result in groups of moving people to stretch out or bunch together as they walk).

Embodiments of the present disclosure incorporate the effect of casualties into the processes being used to simulate and/or predict movement, such as troop movement. For example, some embodiments incorporate a modified form of Lanchester-type attrition modelling. Some forms of attrition modeling assume that the rate of casualties in a fixed area of a conflict depended on the numbers of each antagonist in that area and a rate coefficient representing the effectiveness of fire. While some embodiments of the present disclosure may incorporate models that, in a broad sense, may be used in discrete war game simulations, using these concepts in a continuous flow model (as described below in Section 2) provides advantages not realized in discrete models. For example, discrete models are deterministic, meaning that the output is always the same for the same inputs. Moreover, discrete models are used rigidly at all levels of aggregation (grouping of personnel and equipment into units). Still further, these discrete models are models of attrition only, and not models addressing the broader concept of combat. For example, these discrete models do not include movement of the engaged forces and apply only to a fixed area of the battlefield where all the individuals are engaged in combat. However, as can be seen in more detail below, embodiment of the present disclosure utilize attrition modeling (for example approaches extending aggregated approaches to distributed models) treating troops per unit area.

Lanchester's original model has obvious deficiencies for a case where the numbers of individuals on opposite sides of the battlefield are substantially different. For example, very few targets might be available to the shooters in a counter-insurgency scenario.

The term aggregation as used herein describes the resolution of the simulation. Low aggregation corresponds to more detail, accounting for smaller groups or even individual soldiers. High aggregation lumps forces into large units, perhaps combining heterogeneous forces such as tanks, infantry, and artillery into an equivalent unit. Different choices in the level of aggregation may alter the form of the attrition model used in embodiments of the present disclosure. The continuous flow model used in embodiments of the present disclosure avoids arbitrary aggregation, unlike previous discrete models, and overcomes difficulties realized by prior simulations.

Embodiments of the present disclosure utilize a continuous battle flow model based on crowd flow and/or attrition models. For simplicity in explanation, the following description is restricted to embodiments with forces consisting only of infantry, but other embodiments utilize any other types of forces used in modern warfare. Moreover, while the present description assumes the infantry personnel are restricted to walking, additional embodiments utilize quicker types of movement such as running and/or vehicle transportation.

Embodiments of the present disclosure employ continuous crowd flow models based on conservation of individuals, which can have some analogy to the conservation of mass in fluid mechanics. Assuming the density of individuals per area of a unit i is ρᵢ, the individuals have a walking velocity \vec{u}ᵢ, and the rate of casualties per area is ωᵢ, embodiments of the present disclosure calculate the requirement for conservation of individuals as:

$$\frac{\partial {ρ}_{i}}{\partial t} = - ∇ \cdot ( {ρ}_{i} {\vec{u}}_{i} ) - {ω}_{i} \qquad ( 1 )$$

Equation (1) defines the rate of change of troop density in a small region is equal to the net flow of individuals into that region minus the rate of casualties. In other words, individuals can be tracked, and do not spontaneously appear or disappear.

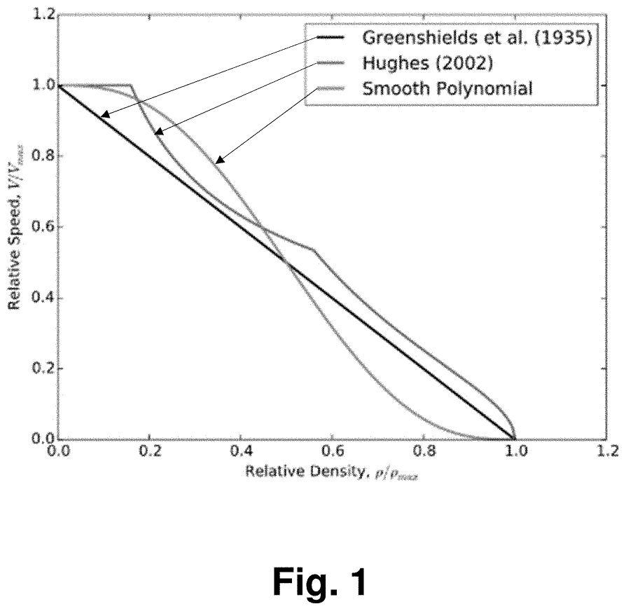

FIG. 1 is a representation of normalized walking speed as a function of normalized crowd density for previous models by Greenshields et al. (1935), Hughes (2002), and the a smooth polynomial function of Equation (3), which may be used in various example embodiments of the present disclosure.

In order to solve Equation (1), a relationship is used for the speed and direction of walking as a function of local conditions. That is, embodiments utilize Equation (2) for directed pedestrian motion, where \vec{V} is the walking velocity, Vₘ is the maximum speed, f(ρ) is a relative speed function, \vec{d} is a unit vector in the direction of walking, and ρ=Σᵢρᵢ is the total troop density at a given location. Embodiments of the present disclosure use estimates of walking speeds, which may be obtained from empirical data. For example, some empirical data indicates that maximum walking speed is approximately 1.4 m/s and embodiments can assume that pedestrian speed is maximized at zero crowd density and drops to zero speed at maximum crowd density, which in some empirical studies is approximately 5.6 individuals/m².

$$\vec{V} = {V}_{m} f ( ρ ) \vec{d} \qquad ( 2 )$$

Two known models are shown in FIG. 1 with the speed and density normalized by the maximum values. Greenshields et al. (1935) proposed a simple linear model (black line), whereas Hughes (2002) argued for a more complex function but model (green line) that is discontinuous in certain locations. While some embodiments of the present disclosure use known models, others utilize smooth polynomial (red line) function models such as Equation (3), where Vₘ=1.4 m/s, ρₘ=5.6 individuals/m², and the speed is assumed to be zero for densities greater than the maximum. The function f(ρ) has advantages in that it is continuous, monotonic, and has zero derivative at the boundary values of the density ρ=0 and ρ=ρₘ.

$$f ( ρ ) = - 6 {( \frac{ρ}{{ρ}_{m}} )}^{5} + 15 {( \frac{ρ}{{ρ}_{m}} )}^{4} - 10 {( \frac{ρ}{{ρ}_{m}} )}^{3} + 1 \qquad ( 3 )$$

Embodiments of the present disclosure also account for the effects of terrain. The height of the ground can be represented by a function of position on the map h(x,y), and the local height gradient is ∇h. The gradient vector points directly uphill with a magnitude equal to the ground slope in that direction. There are two characteristic directions that may also be utilized, the walking direction \vec{d} and the uphill direction \vec{n}. See the discussion below concerning the walking direction vector. The uphill vector can be found from the normalized height gradient

n=∇h/|∇h|.

Modifying the equation for directed motion (Equation (2)) to account for the effect of ground slope in the direction of travel s=\vec{d}·∇h, one or more options for behavior of the unit (for example, infantry troops) can be used to simulate/compute behavior in response to terrain, which offers improved realism over previous models. The variable s is the directional derivative, that is the slope in the direction of walking.

The first option for the behavior of a unit in response to terrain (referred to as Option 1, rigid orientation, for discussion purposes) can be simple modification of the walking speed as represented in Equation (4). Here, the new function is restricted to the range 0≤g≤1, where g=1 on level ground (no effect) and g=0 on extremely steep terrain (no progress). In Option 1, the walkers rigidly maintain their direction, but are slowed on an incline. Under this model, the portion of a unit that is on a shallow uphill slope can move faster than the portion on a steeper slope, so the unit as a whole can turn despite the rigid direction of the subunits. This type of model for behavior can be thought of as being analogous to a tank turning because the treads on one side are moving faster than on the other.

$$\vec{V} = {V}_{m} f ( ρ ) g ( s ) \vec{d} \qquad ( 4 )$$

Another option for the behavior of a unit in response to terrain (referred to as Option 2, flexible orientation, for discussion purposes) reduces the uphill component of walking velocity while the velocity component along the topographic contours is unaffected. A mathematical representation of the modified direction vector representing an example of this model is shown in Equation (5):

$$\vec{V} = {V}_{m} f ( ρ ) \cdot [ \vec{d} - ( 1 - g ( \vert ∇ h \vert ) ) ( \vec{d} \cdot \vec{n} ) \vec{n} ] \qquad ( 5 )$$

In Equation (5) the uphill component of velocity (\vec{d}·\vec{n})\vec{n} is subtracted and a smaller value (g times the original component) is added back. Here the argument of the function g is the full magnitude of the slope and not the component in the direction of movement (walking). The walkers in this option tend to roughly follow the topographic contours and each subunit turns slightly to follow the contour around a hill. The subunits on a steeper slope turn more and move more slowly than the subunits on a shallower slope, producing a somewhat stronger rotation of the unit as a whole than under Option 1.

An estimate of the function g can be used to examine the effect of the two options in various examples. There should be a different effect for uphill and downhill travel, so speed should be a function of both the steepness and the direction of travel. A reasonable function to adjust walking speed for moderate (but not extreme) slopes used in some embodiments is represented in Equation (6):

$$g ( s ) = \{ \begin{matrix}\frac{1}{1 + 3.5 s} , & s > 0 ( uphill ) \\ 1 , & s < 0 ( downhill )\end{matrix} \qquad ( 6 )$$

Equation (6) reduces uphill walking speed to 97% for a height gradient of s=0.01 (for example, up 10 m per 1000 m horizontal distance, i.e., a rise/fall of 10 m over a distance of 1000 m) and to 74% for a height gradient of s=0.1 (for example, up 100 m per 1000 m horizontal distance, i.e., a rise/fall of 100 m over a distance of 1000 m). Some embodiments assume that walking downhill does not affect speed, while additional embodiments assume that walking downhill increases speed to a limiting maximum walking speed.

For comparison purposes, a moderate rate of climbing stairs is one floor in approximately 20 s. The slope of stairs is about s=0.64, for a standard 7-inch rise per 11-inch run and 30 steps per floor in the United States. The corresponding velocity components are a 0.27 m/s climb rate and a 0.42 m/s horizontal rate. The rate of horizontal progress while climbing stairs (0.42 m/s) is therefore about 30% of that of that on flat ground (1.4 m/s). Using functions as disclosed herein for embodiments of the present disclosure a consistent answer is predicted: g(0.64)=0.31.

Embodiments of the present disclosure also specify the direction of the crowd flow \vec{d}. This is the desire of each pedestrian (unit) to reach a destination, which can also be referred to as goals of the subunits within the group. In the military model, this has analogies to a unit following orders. Here, the crowd flow can be characterized by a potential ϕᵢ(\vec{x}), which varies with position \vec{x} and type i of the pedestrian. The potential is minimum at the destination. In some embodiments, the pedestrians are assumed to walk in the direction of the maximum decrease of potential. For this model, the walking direction vector is represented by Equation (7):

$${\vec{d}}_{i} = - \frac{∇ {ϕ}_{i}}{\vert ∇ {ϕ}_{i} \vert} \qquad ( 7 )$$

Generally speaking, Equations (4)-(7) represent terrain modeling according to at least one embodiment of the present disclosure.

Other embodiments specify the direction of pedestrian movement and rules of different forms. For example, in at least one embodiment the velocity itself (not the direction) is taken as the gradient of a potential, which produces a more fluid-like infantry flow, which incorporates accelerating downhill.

Some embodiments have the units slow down and stop as they reach their destination, such as by assigning a minimum value for the denominator on the right-hand-side of Equation (7). An example minimum value is around 0.1 L, that is 10% of the battlefield length scale. In this embodiment, within a small circle of radius 0.1 L around the destination, the magnitude of the vector \vec{d}ᵢ drops toward zero as the destination is approached.

Still further embodiments compute the potential required to represent orientation and relative positioning of military units. In these embodiments portions of each unit (small subunit or infinitesimal fluid particle) are distinguished, which allows them to be independently directed. One optional way for accomplishing this task is to track each unit by its initial position. In this way the subunits are identified by their position vector in the initial formation, and they retain that information as they move. In determining the initial position \vec{ξ} ᵢ of a subunit (position at time t=0) that is currently at \vec{x}ᵢ (position at current time t), some embodiments solve an additional equation, such as Equation (8), which may be referred to as a subunit identity equation:

$$\frac{\partial {\vec{ξ}}_{i}}{\partial t} + ( {\vec{u}}_{i} \cdot ∇ ) {\vec{ξ}}_{i} = 0 \qquad ( 8 )$$

In fluid dynamic terms, the material derivative of \vec{ξ} ᵢ in Equation (8) is zero, which results in a purely kinematic relationship for the motion of a material point.

Alternate embodiments expand the definition of the potential to include variation with both position and subunit identity. In these embodiments, the potential becomes ϕᵢ(\vec{x}ᵢ, \vec{ξ}ᵢ), and the gradient is taken with respect to \vec{x} at constant \vec{ξ}ᵢ.

Some embodiments express the intended behavior as a potential using, for example, Equation (9). In these embodiments the potential is related to the distance from a subunit's current position \vec{x} to that particular subunit's goal position \vec{z}ᵢ(\vec{μ}ᵢ). The square is an optional feature that can be used for mathematical convenience.

$${ϕ}_{i} ( \vec{x} , {\vec{ξ}}_{i} ) = {\vert \vec{x} - {\vec{z}}_{i} ( {\vec{ξ}}_{i} ) \vert}^{2} \qquad ( 9 )$$

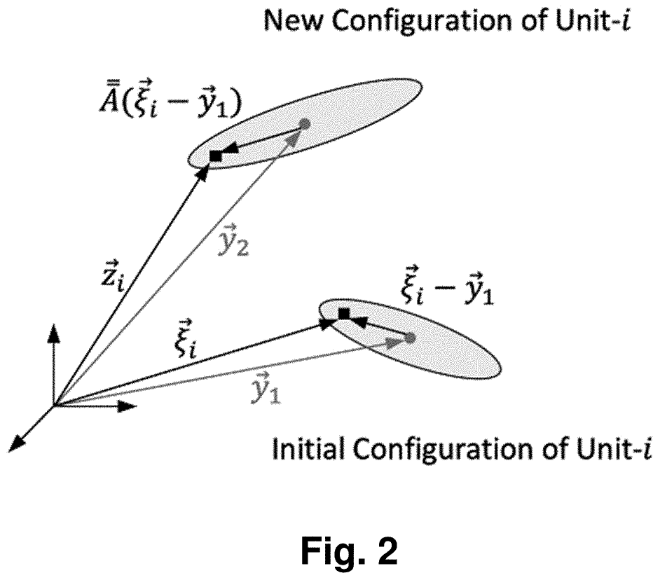

Depicted in FIG. 2 is a model for relative motion and orientation. In some example embodiments, this is defined as unit translation and rotation as expressed, for example, by Equation (10), taking a typical initial point \vec{ξ} ᵢ to a new location \vec{z}ₜ.

Some embodiments express the goal position using an equation such as Equation (10). This represents a change from an initial configuration around center \vec{y}₁ to a new center around \vec{y}₂, subject to rotation and stretching of the coordinate system through the matrix A̅. See, for example, FIG. 2. If the soldiers (units) have orders to reform their initial configuration around a new center, then A̅ is the identity matrix I̅.

$${\vec{z}}_{i} = {A}^{\overline{\_}} ( {\vec{ξ}}_{i} - {\vec{y}}_{1} ) + {\vec{y}}_{2} \qquad ( 10 )$$

Further embodiments implement even more complex motions through rotation and stretching of the coordinate system. For example, the transformation expressed in Equation (11) rotates the initial configuration anticlockwise through an angle θ and stretches it by the factors a and b along the respective coordinate axes. The model expressed in Equation (8) through Equation (11) is, to the knowledge of the inventors of the present disclosure, a new contribution to the literature. In embodiments implementing Equation (11), Equation (11) facilitates more realistic motion and orientation relative to other two-dimensional battle flow models.

$${A}^{\overline{\_}} = [ \begin{matrix}a cos θ & - b sin θ \\ a sin θ & b cos θ\end{matrix} ] \qquad ( 11 )$$

Generally speaking, Equations (9)-(11) represent how orders are taken into account according to at least one embodiment of the present disclosure.

Additional embodiments improve realism by adding at least one diffusion component to the model to capture the tendency of the crowd to mix through random agitation. In some embodiments a standard diffusion model in which diffusion velocity is proportional to the density gradient is used. In these embodiments, the final form of the pedestrian velocity is represented by Equation (12).

$${\vec{u}}_{i} = \vec{V} ( ρ , ∇ h , {\vec{d}}_{i} ) - \frac{{D}_{i}}{{ρ}_{i}} ∇ {ρ}_{i} \qquad ( 12 )$$

Drawing analogies to the physical diffusion in gases for illustrative purposes, the crowd diffusion coefficient can be proportional to a characteristic crowd agitation speed and an average distance between human interactions. Some embodiments estimate the diffusion coefficient to have a relatively small value of D=1.0×10⁻³ m²/s, although other embodiments can use other values for the diffusion coefficient. Embodiments of the present disclosure utilize a level of diffusion that is low relative to directed motion, which can help avoid unrealistically smearing out troop concentrations over time. For example, in some embodiments the level of diffusion is at least an order of magnitude smaller than the speed of directed motion, and in further embodiments the level of diffusion is set to zero.

While some embodiments implement local convolution integrals to promote cohesion of troops, other embodiments that may be preferred use Equation (8) through Equation (11), which are less computationally expensive than convolution integrals.

In some embodiments attrition, such as attrition due to close-in combat, is modelled utilizing a modified form of the Lanchester area fire model as represented in Equations (13) and (14), which provides advantages when used in the context of the continuous flow formulation utilized in various embodiments of the present disclosure.

$$\begin{matrix}\frac{dR}{dt} = - \tilde{b} RB & ( 13 ) \\ \frac{d B}{dt} = - \tilde{r} RB & ( 14 )\end{matrix}$$

The rate of fire in the modified model is proportional to the local concentration of attackers and the number of available targets is proportional to the local density of defenders. Considering two units as an illustrative example, the loss rate for one unit due to combat with another is the product of a loss rate coefficient kᵢⱼ and the densities of the interacting units ρ₁. The total casualty rate for a given unit is the sum over all enemy units present locally. The casualty rate is modeled by Equation (15), which has analogies to a set of binary reactions in chemical kinetics.

$${ω}_{i} = {\sum }_{j} {k}_{ij} {ρ}_{i} {ρ}_{j} \qquad ( 15 )$$

The loss rates in Equation (15) are not necessarily symmetric. In other words, generally speaking k₂₁≠k₁₂, which indicates that the armies do not necessarily inflict equal casualties on each other. For armies that are not enemies, the loss coefficient may be taken to be equal to zero. However, other embodiments utilize a non-zero loss coefficient to represent casualties due to friendly fire.

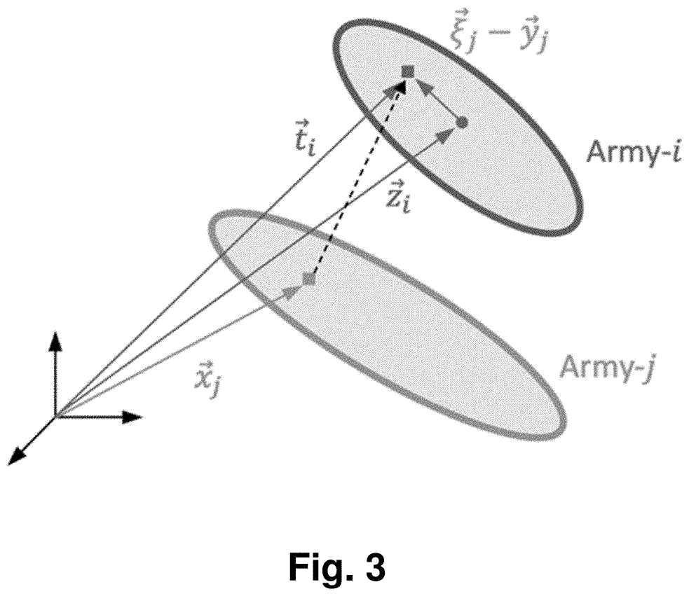

Depicted in FIG. 3 is a ranged fire model representing a subunit of Army-j (Red) firing on designated target in Army-i (Blue) according to embodiments of the present disclosure. To treat casualties due to ranged fire it is assumed that each subunit in Army j (identified by initial position \vec{ξ}ⱼ, and currently at \vec{x}ⱼ) has an assigned target subunit in Army i labelled as \vec{t}ᵢ. In some embodiments it is assumed that the target is the corresponding location in the initial configuration relative to the current centroid of the enemy army, \vec{t}ᵢ\vec{ξ}ⱼ−\vec{y}ᵢ+\vec{z}ᵢ, where \vec{y}ⱼ is the initial center of Army j and \vec{z}ᵢ=∫∫ρᵢ\vec{x}dA/∫∫ρᵢdA is the current centroid of Army i. In other words, it is assumed in these embodiments that the troops fire in a pattern around the enemy center. It can also be assumed that the effectiveness of ranged fire varies with distance between these subunits rᵢⱼ=|\vec{t}ᵢ−\vec{x}ⱼ| and/or that the casualty rate is proportional to the density of targets and the density of units firing, resulting in Equations (16) and (17).

$$\begin{matrix}{ω}_{i}^{′} = {\sum }_{j} {k}_{ij}^{′} f ( {r}_{ij} ) {ρ}_{i} {ρ}_{j} & ( 16 ) \\ f ( {r}_{ij} ) = \{ \begin{matrix}1 , & {r}_{ij} < {R}_{o} \\ {( \frac{{R}_{0}}{{r}_{ij}} )}^{2} , & {r}_{ij} \geq {R}_{0}\end{matrix} & ( 17 )\end{matrix}$$

In Equation (17), ranged fire at very close enemies (r<R) is assumed to be as effective as close-in combat, but for longer ranges (r≥R₀) the effectiveness of ranged fire drops as the reciprocal of distance squared, which corresponds to the visually apparent target area. For an example discussed below, R₀=50 m. The model of ranged fire is Equations (16) and (17) is based on realistic geometric constraints and has advantages over other embodiments that may utilize other approaches, such as being substantially more computationally efficient than approaches such as those using convolution integrals.

At least one study of the Ardennes campaign during WWII, which is frequently referred to as the Battle of the Bulge, found coefficients for the Lanchester area fire model on the order of 1×10⁻⁸/(day soldier), which is around one thousand casualties per day per army for two armies, each with three to four hundred thousand soldiers. Assuming that the Ardennes campaign corresponded to a battle area on the order of 100 km by 100 km, and that the intensity of combat was uniformly distributed over time, the corresponding loss coefficient is on the order of k=1×10⁻³ m²/(s·individual). More likely, the losses would have been concentrated in brief periods of intense battle, interspersed with longer periods without contact with the enemy. Here we assume (arbitrarily) that a given portion of the army was engaged in intense fire on the order of 1% of the time, resulting in an estimated loss coefficient of k=1×10⁻¹ m2/(s·individual).

With these assumptions, infantry combat models according to embodiments of the present disclosure include use of Equations (1)-(17). These systems use a standard set of convection-diffusion equations with a source term, which may be thought of as being analogous to models used in physical science to model drift-diffusion motion of reactive chemical species. In the numerical examples presented next, at least one model is solved using a standard implicit upwind method (second order in space and time, employing a minmod limiter) for this class of equations, which may be implemented using relatively short programs written in various programming languages, such as C++.

In some embodiments a numerical approach is used that casts Equation (1) in a strong conservation form where U is the dependent solution variable and E and F are fluxes, such as represented by Equation (18).

$$\frac{\partial U}{\partial t} + \frac{\partial E}{\partial x} + \frac{\partial F}{\partial y} = S \qquad ( 18 )$$

Equation (18) can be discretized in finite difference form as Equation (19), where the term Un represents the solution variable at time level n. Here L is an operator associated with linearization of the implicit time scheme about the solution in the last subiteration U. Quasi-Newton subiterations are used to drive ΔU→0 and U^{p}→Uⁿ⁺¹. Here E^{±} and F^{±} correspond to fluxes associated with right- and left-running waves and δₓ^{±} and δ_{y}^{±} correspond to the appropriate second-order, upwind, discrete spatial derivative operators.

$$L Δ U = \frac{3 {U}^{p} - 4 {U}^{n} + {U}^{n - 1}}{2 Δ t} + {δ}_{x}^{-} {E}^{+} + {δ}_{x}^{+} {E}^{-} + {δ}_{y}^{-} {F}^{+} + {δ}_{y}^{+} {F}^{-} \qquad ( 19 )$$

The kinematic equations (8) may also be cast in a nonconservative form as represented by Equation (20), and may be discretized in a form represented by Equation (21), where L is another implicit operator. Again, subiterations are used to drive ΔU→0 and U^{p}→Uⁿ⁺¹. The terms A^{±} and B^{±} correspond to the coefficients associated with right- and left-running waves.

$$\begin{matrix}\frac{\partial U}{\partial t} + A \frac{\partial U}{\partial x} + B \frac{\partial U}{\partial y} = S & ( 20 ) \\ L Δ U = \frac{3 {U}^{p} - 4 {U}^{n } + {U}^{n - 1}}{2 Δ t} + {A}^{+} {δ}_{x}^{-} U + {A}^{-} {δ}_{x}^{+} U + {B}^{+} {δ}_{y}^{-} U + {B}^{-} {δ}_{y}^{+} U & ( 21 )\end{matrix}$$

To explore the qualitative behavior of at least one model according to embodiments of the present disclosure, example calculations utilizing Equations (1)-(17) for two armies of infantry (Red and Blue) are used. In the example the battlefield was taken to be a square with side L=1000 m, that is 0≤x≤1.0 km, 0≤y≤1.0 km. For baseline computations, the computational mesh consisted of 401×401 points and the time step was 0.25 s. The computation for each scenario was run for a total of 600 s (10.0 min) of simulated time (2400 time-steps).

To assess the effect of spatial resolution on the results in the following basic example, coarse grid calculations were carried out with 201×201 points (doubling Ax and Ay versus the 401×401 point baseline case) and fine grid calculations were carried out with 801×801 points (half the mesh spacing). The results were qualitatively consistent between the cases, although mesh refinement tended to bring out small-scale details. A corresponding time resolution study indicated that the baseline case was well-resolved in time.

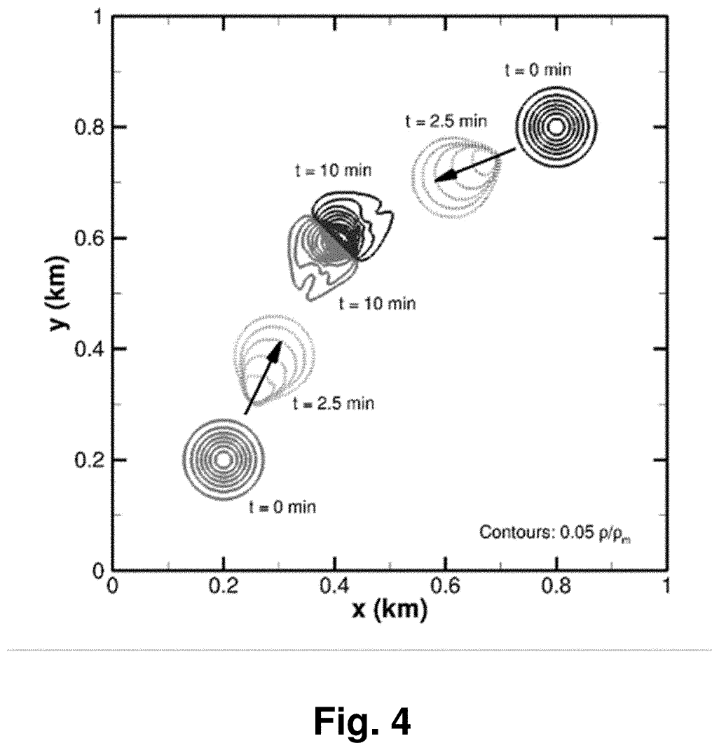

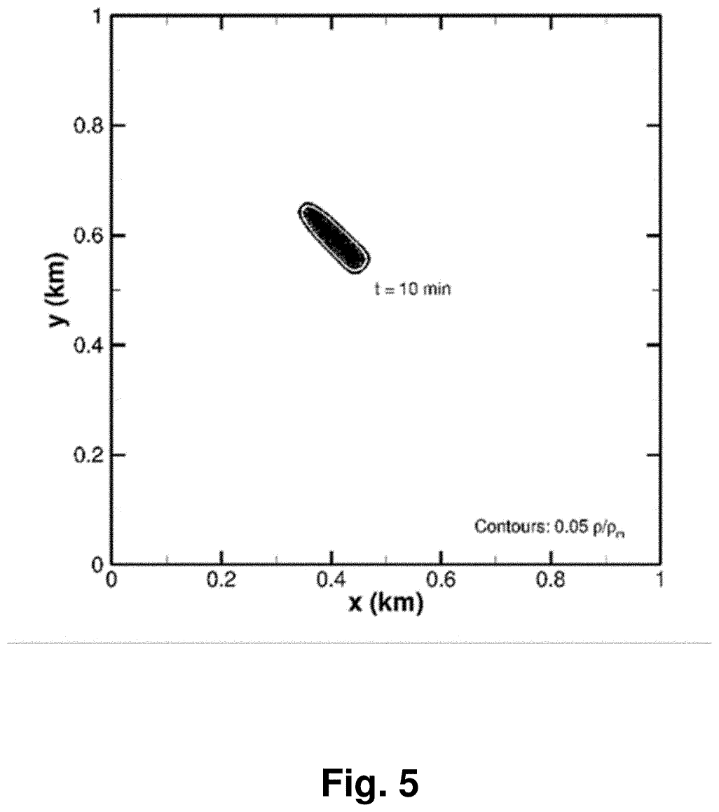

A basic example simulation according to embodiments of the present disclosure is depicted in FIGS. 4 and 5. In this example embodiment there is an absence of terrain, pivoting motion, breakpoints, and ranged fire. FIG. 4 depicts the density of each army at different times and FIG. 5 depicts casualties at the end of the simulation. Each figure displays the probability as contour lines of equal probability according to at least one embodiment of the present disclosure. Density is scaled as ρᵢ/ρₘ. The initial (t=0 min) distributions of the two armies are specified as Gaussian functions and represented in Equation (22).

$${ρ}_{i} = {ρ}_{i 0} exp [ \frac{- {( \frac{x - {x}_{1 , i}}{{ℓ}_{x , i}} )}^{2} - {( \frac{y - {y}_{1 , i}}{{ℓ}_{y , i}} )}^{2}}{π {ℓ}_{x , i} {ℓ}_{y , i}} ] \qquad ( 22 )$$

The initial state of Army 1 (Red) is centered at (x_{1,1},y_{1,1})=(0.2,0.2) and spread out over a scale ( [symbol] _{x,1}, [symbol] _{y,1})=(0.05,0.05), where the distance is in kilometres. Army 2 (Blue) is initially spread out over the same scale, but it is centered at (x_{1,2},y_{1,2})=(0.8,0.8). The characteristic density of each army was taken to be ρ₁₀=ρ₂₀=1.68×10⁻² individuals/m2. Both troop densities (FIG. 4) and total casualty density (FIG. 5) were tracked.

In this example embodiment fictitious battle, the orders to each army, Equation (10), are to form up in another circular formation around the new center θ=0° and a=b=1, so A̅=I̅). Red is ordered to move its center to (x_{2,1}, y_{2,1})=(0.39,0.59) and Blue to (x_{2,2}, y_{2,2})=(0.41,0.61). The results at time 2.5 min are depicted in FIG. 4 and illustrate their initial response. The density virtual soldiers in the depicted distributions attempt to execute their orders as directly as possible within the constraints of their surroundings. Because the speed of subunit movement decreases with troop density, Equation (13), each advancing army tends to pile up in the rear and stretch out in the front in a similar manner as runners at the start of a large road race. The troop distributions deviate from their initial symmetric arrangement in space and the maximum density drops as the troops spread out. The result is a droplet-shaped configuration for each moving army.

At the final time of 10.0 min, the two armies have come into contact and casualties have appeared. Combat prevents the armies from significantly interpenetrating one another and a linear front arises. The appearance of this front is a consequence of Equation (15), which in this example embodiment depicts only local fighting with no ranged combat. As time continues, casualties mount. There is no mechanism to disengage from battle in this example embodiment; combat will continue until one of the armies is gone. Logic to include breakpoints, such as decisions to terminate battles, are incorporated into various embodiments to create more realistic simulations, such as those represented in the next example.

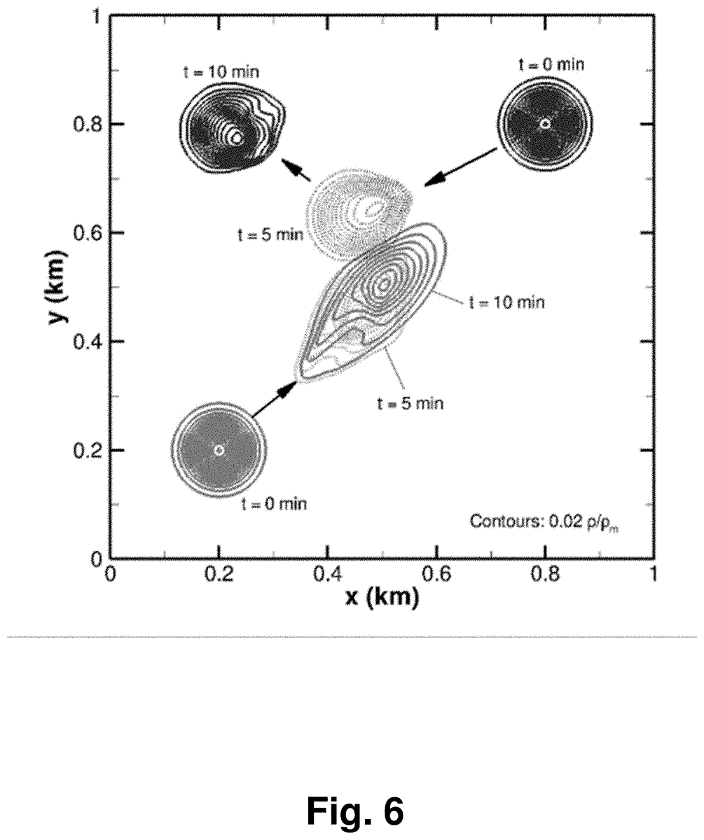

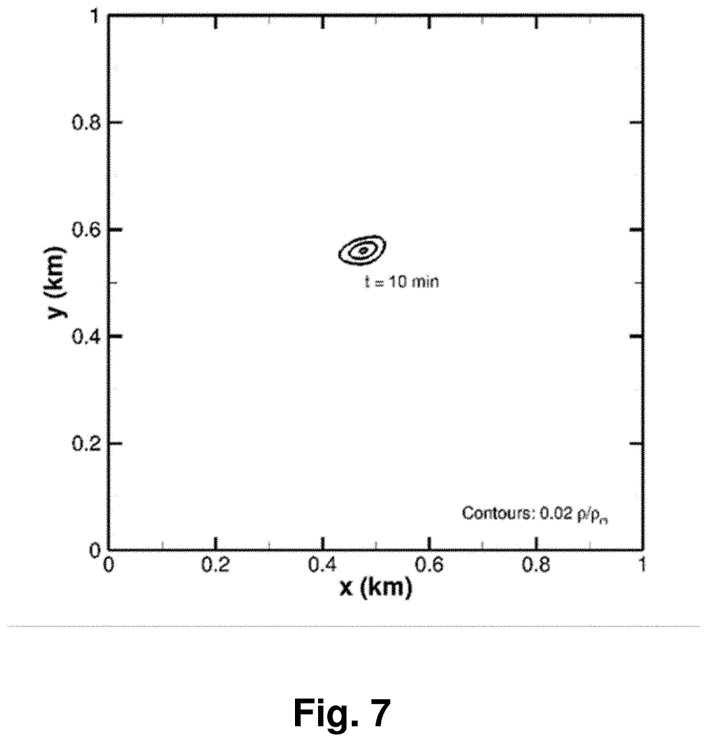

FIGS. 6 and 7 depict the results of an example simulation according to additional embodiments of the present disclosure. Unit reorientation and a breakpoint are included in this example. Again, ranged fire is omitted. FIG. 6 depicts the density of each army at different times and FIG. 7 depicts casualties at the end of the simulation. Each figure displays the probability as contour lines of equal probability according to at least one embodiment of the present disclosure and density is again scaled as ρᵢ/ρₘ. The initial conditions and army parameters remain the same.

In this example, Red is ordered to move its center to (x_{2,1},y_{2,1})=(0.5,0.5) km, and to pivot and reform along an angled front such that a=2,b=1, and θ=45°. Blue is ordered to disengage if its casualties exceed 500 individuals, and to retreat to a new position centered around (0.2,0.8) km.

The arrows in FIG. 6 indicate the recent motion of the two armies. At time 5.0 min, Red has neared its goal position and has begun spread out in an angled ellipsoidal pattern as ordered. Blue has approached closely and a region of mounting casualties appears between the armies. Blue's casualties soon exceed Blue's threshold of 500 casualties, and by time 10.0 min Blue has retreated toward its fallback position, illustrating a breakpoint.

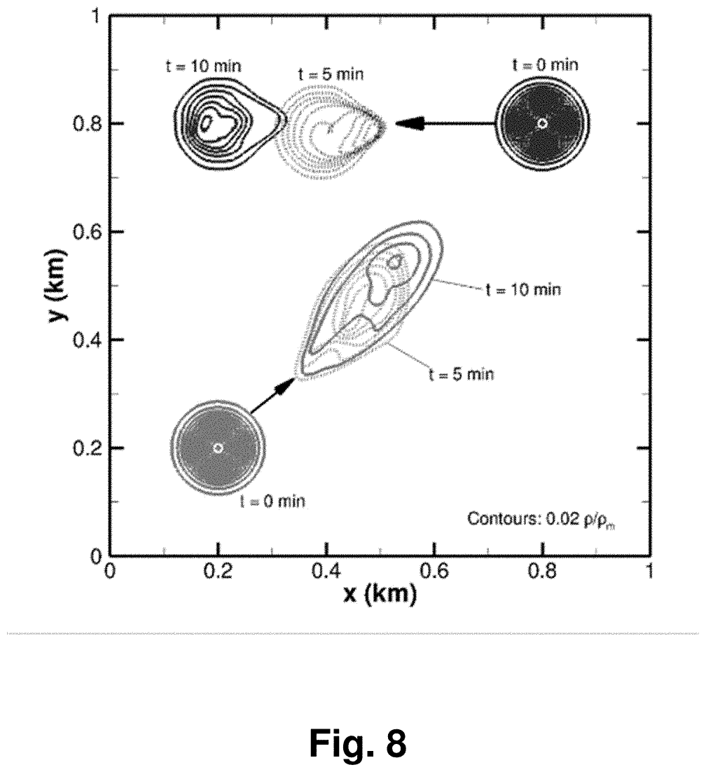

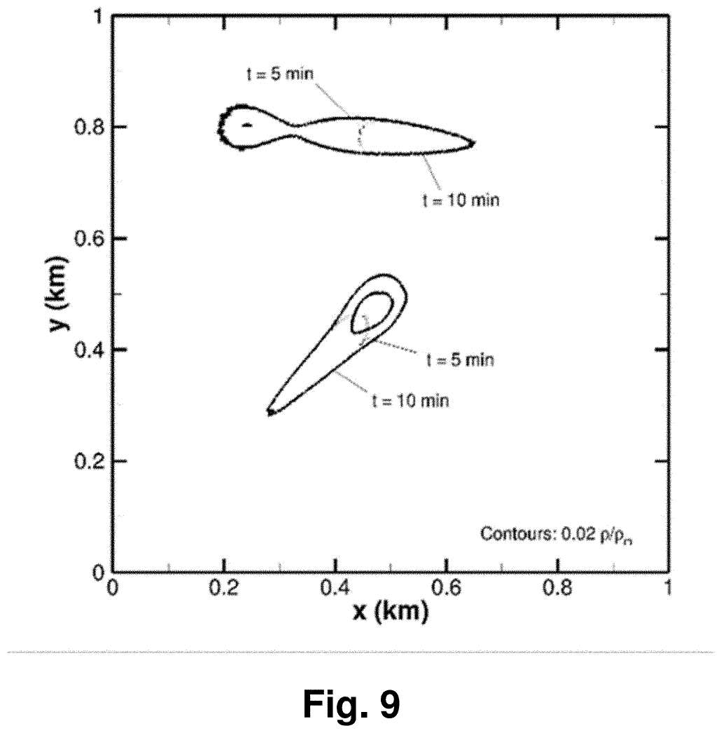

FIGS. 8 and 9 depict the results of an example simulation according to additional embodiments of the present disclosure. Ranged fire is now added to the previous example embodiment. FIG. 8 depicts the density of each army at different times and FIG. 9 depicts casualties at the end of the simulation. Similar to above, the figures display the probability as contour lines of equal probability and density is again scaled as ρᵢ/ρₘ. The initial condition remains the same and the battle orders correspond to an angled elliptical formation for Red and a possible retreat for Blue as in the previous example embodiment.

The history of the motion of the armies is evident through the trail of casualties depicted in FIG. 9. Having rapidly taken casualties through ranged fire, Blue changes course very early on to move to its fallback position. With the enemy in retreat, Red is able to assume its goal formation around (0.5, 0.5) km. In this example, ranged fire has the expected effect of keeping the enemy at bay.

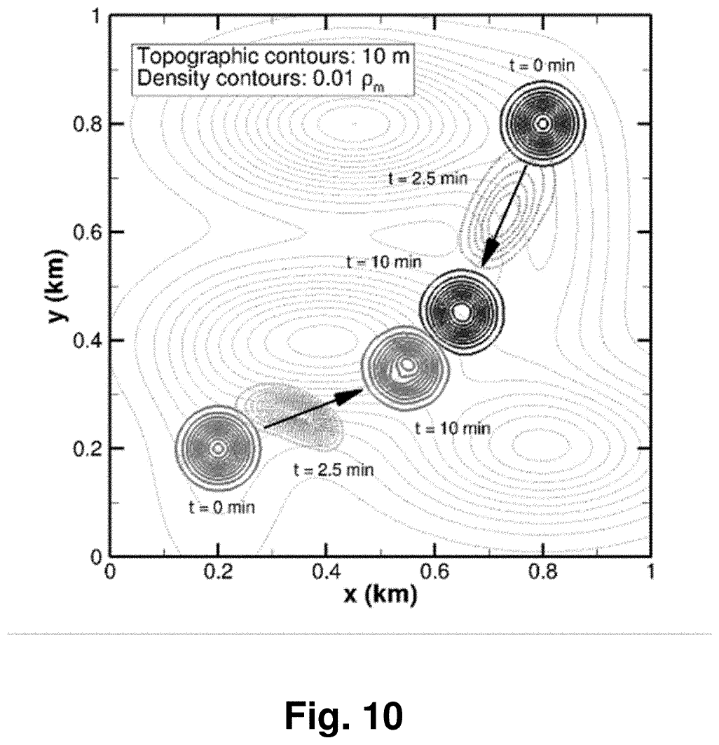

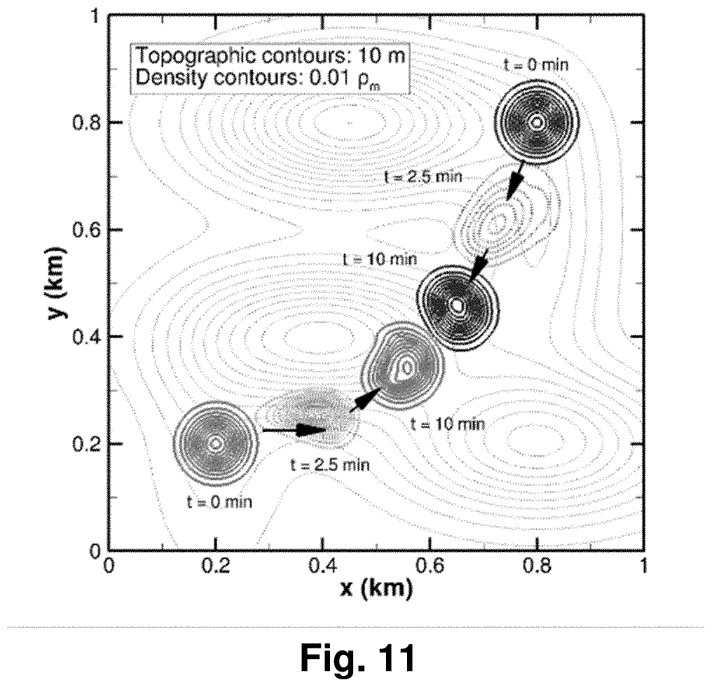

FIGS. 10 and 11 depict the results of an example simulation according to still additional embodiments of the present disclosure. This example illustrates the behavior of the two options for modelling terrain outlined in Equation (14) and Equation (5). The dotted black contours indicate ground height. Red and blue contours indicate troop density of opposing units. FIG. 10 depicts the results of Option 1—rigid formation. FIG. 11 depicts the results of Option 2—flexible orientation.

The topographical map is shown with dotted contours at 10 m intervals. There are peaks of order 100 m height at (0.80,0.20), (0.40,0.40), (0.20,0.20), (0.80,0.60), and (0.45,0.80), where the coordinates are in km. Contours of troop density for each unit (red and blue) are shown for 0.0 min, 2.5 min, and 10.0 min of elapsed time. For both options, motion is slowed by an uphill climb, and the units tend to turn away from steep slopes to follow the topographic contour lines. For Option 2, the tendency to turn is very strong, leading to a sinuous path that follows valley floors. In some embodiments, the topographic map is replaced by three-dimensional images to help with rapid interpretation of the information.

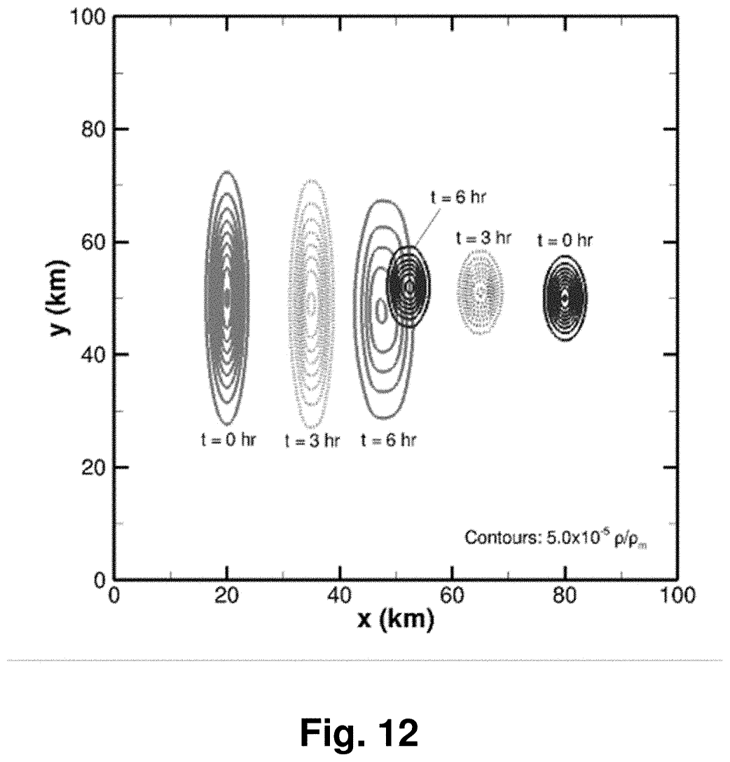

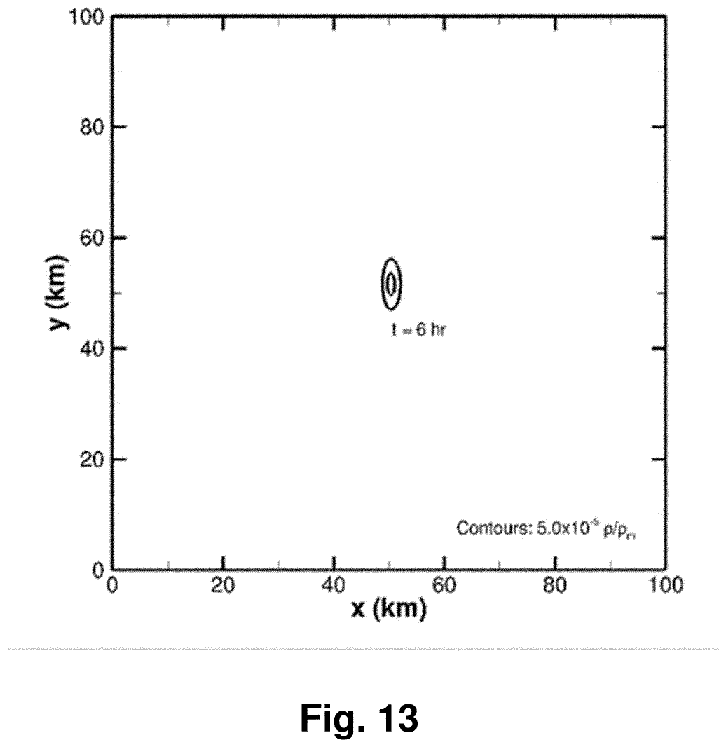

FIGS. 12 and 13 depict the results of an example simulation according to yet additional embodiments of the present disclosure. This example illustrates a large scale example with total density scaled as ρᵢ/ρₘ as in the above examples. FIG. 12 depicts the density of each army at different times and FIG. 13 depicts casualties at the end of the simulation.

For this example the domain is set to a scale comparable to that of the 1944-1945 Ardennes Campaign: 100 km by 100 km. The grid is maintained at 401×401 points, but the time step is increased to 30 s. Run time is for 1440 time steps and a time interval of 12 hr is simulated.

Red (3.0×10⁵ troops) is initially centered at (20,50) km, spread over characteristic scales of (2.5,15) km; the corresponding data for the smaller Blue force (1.0×10⁵ troops) are (80,50) km, spread over characteristic scales of (2.5,5) km. Red attempts to shift to (48,48) km and Blue to (52,52) km. At this low troop density, walking motion is not impeded and the droplet-shaped configurations depicted in FIGS. 4-11 are not seen here. Of note is the symmetrical distributions at the 3 hr mark in FIGS. 12 and 13. The behavior of this example embodiment is as would generally be expected; the armies have made contact at the 6 hr mark, with casualties on the order of 2×10⁴ for each side.

The representations of units depicted in FIGS. 4-13 may be implemented on one or more displays to provide representations of the simulations that are easy for users to understand and interpret.

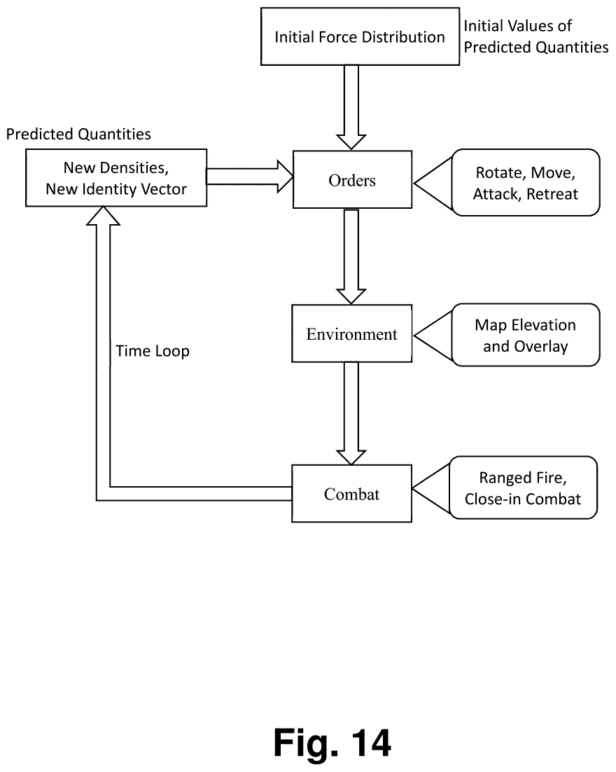

FIG. 14 illustrates a flow chart representing various embodiments of the present disclosure. For example, for many embodiments the initial parameters are set by assigning initial values of predicted quantities and setting the initial force distribution(s). This may include establishing one or more of the parameters mentioned in this disclosure, such as: topographical map (terrain), overlays on the map (for example, trees, grass, fences, houses, etc.), initial configuration of the groups (for example, infantry troops), the orders for each unit (for example, locations to move toward, directions of movement, incentive to engage or flee from an enemy, etc.), numbers of units, and/or effectiveness of units.

Once the initial parameters are established and input, computations are conducted to determine what occurs at the next time increment. For example, the computations may calculate velocities of the probability distribution of the group's location taking into account one or more influencing factors on the group, such as orders (command instructions to rotate, move, attack, retreat, etc.), environment (such as map elevation and various overlays such as trees, grass, fences, houses, general impediments, etc.) and combat influences (such as ranged fire, close-in combat, etc.). The influencing factors associated with a particular embodiment are used to calculate a new probability distribution and new identity vectors of the group at the end of the time step. These predicted quantities are then fed back into the computations for the next time step to achieve a probability distribution and identity vectors of the group at the next time step.

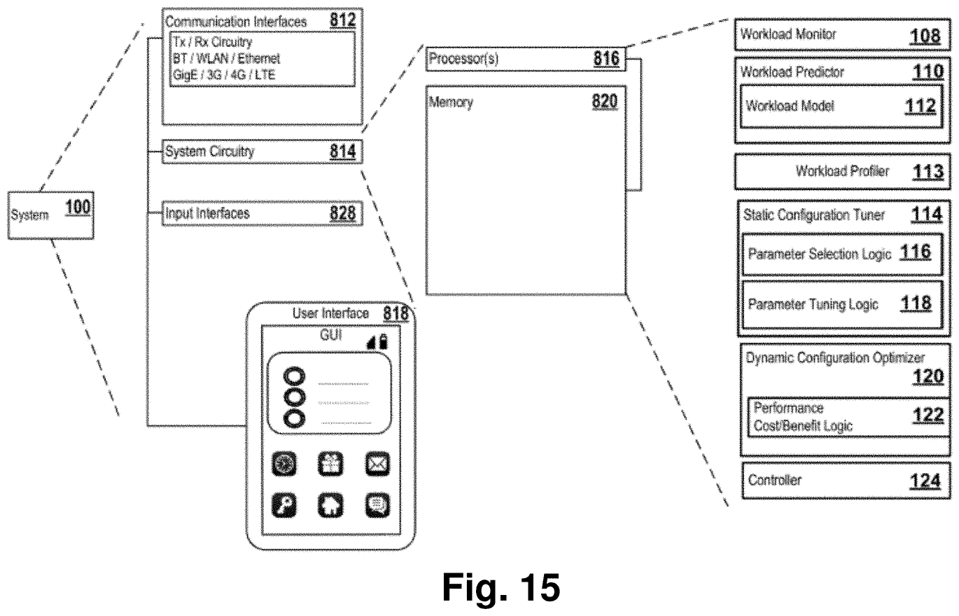

FIG. 15 illustrates an example of a system 100 incorporating the simulations, processes, procedures and/or methods of the embodiments described in this disclosure. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations the workload monitor 108, the workload predictor 110, the workload model 112, the workload profiler 113, the static configuration tuner 114, the perimeter selection logic 116, the parameter tuning logic 118, the dynamic configuration optimizer 120, the performance cost/benefit logic 122, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the workload monitor 108, the workload predictor 110, the workload model 112, the workload profiler 113, the static configuration tuner 114, the perimeter selection logic 116, the parameter tuning logic 118, the dynamic configuration optimizer 120, the performance cost/benefit logic 122, and/or the system 100. Alternatively or in addition, the memory may include any other component or subcomponent of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many ways. In some examples, the system 100 may be implemented with one or more logical components. For example, the logical components of the system 100 may be hardware or a combination of hardware and software. The logical components may include the workload monitor 108, the workload predictor 110, the workload model 112, the workload profiler 113, the static configuration tuner 114, the perimeter selection logic 116, the parameter tuning logic 118, the dynamic configuration optimizer 120, the performance cost/benefit logic 122, the system 100 and/or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

Reference systems that may be used herein can refer generally to various directions (e.g., upper, lower, forward and rearward), which are merely offered to assist the reader in understanding the various embodiments of the disclosure and are not to be interpreted as limiting. Other reference systems may be used to describe various embodiments, such as referring to the direction of projectile movement as it exits the firearm as being up, down, rearward or any other direction.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

What is claimed is:

1. A device, comprising:
one or more processors to:
receive information related to
an initial configuration of personnel in a probability distribution,
subunit identity information including one or more orders that govern what the personnel are intended to achieve, and
environmental information through which the personnel are intended to travel;
generate at the end of a first time step a predicted probability distribution of personnel based on
the initial configuration of personnel,
the subunit identity information, and
the environmental information; and
provide information to a user interface related to the predicted future probability distribution of personnel.

2. The device of claim 1, wherein the one or more processors iteratively perform the following before the one or more processors provide information to a user:
update the predicted probability distribution with a further configuration of personnel;
generate at the end of a further time step a further predicted probability distribution based on
the further configuration of personnel,
the subunit identity information, and
the environmental information; and
provide a further predicted probability distribution and update the predicted probability distribution with the further predicted probability distribution.

3. The device of claim 3, wherein before the one or more processors provide information to a user interface, the one or more processors iteratively repeat the sequence of actions, and wherein the subunit identity is preserved while the one or more processors iteratively repeat the sequence of actions.

4. The device of claim 1, wherein the one or more processors generate the predicted future probability distribution utilizing fluid flow calculations.

5. The device of claim 1, wherein the one or more orders include a desire of each subunit to reach a goal destination by specifying a direction of a crowd flow \vec{d}.

6. The device of claim 5, wherein the crowd flow is characterized by a potential ϕᵢ(\vec{x}) that varies with position \vec{x} and type i of the of subunit, wherein the potential is minimum at the goal destination.

7. The device of claim 1, wherein the initial configuration of personnel included the numbers of units and effectiveness of units.

8. The device of claim 1, further comprising:
a user interface to present the information provided by the one or more processors with contour lines of equal probability of personnel.

9. The device of claim 8, wherein the contour lines of equal probability are displayed on a three-dimensional image of the battlefield.

10. The device of claim 1, wherein the one or more processors receive information related to ranged fire that varies with the distance between subunits, and the predicted probability distribution is further based on casualty rates due to ranged fire.

11. The device of claim 10, further comprising:
a user interface to present the information provided by the one or more processors with contour lines of equal probability of casualties.

12. The device of claim 10, wherein the ranged fire is represented by
$${ω}_{i}^{′} = {\sum }_{j} {k}_{ij}^{′} f ( {r}_{ij} ) {ρ}_{i} {ρ}_{j}$$
and the casualty rate is represented by
$$f ( {r}_{ij} ) = \{ \begin{matrix}1 , & {r}_{ij} < {R}_{o} \\ {( \frac{{R}_{0}}{{r}_{ij}} )}^{2} , & {r}_{ij} \geq {R}_{0}\end{matrix} .$$

13. The device of claim 10, wherein the one or more processors receive information related to attrition due to close-in combat and the predicted probability distribution is further based on casualty rates due to attrition due to close-in combat.

14. The device of claim 13, further comprising:
a user interface to present the information provided by the one or more processors with contour lines of equal probability of casualties.

15. The device of claim 12, wherein the attrition is represented by
$$\frac{dR}{dt} = - \tilde{b} RB and \frac{d B}{dt} = - \tilde{r} RB .$$

16. The device of claim 1, wherein the predicted probability distribution of personnel is further based on at least one diffusion component for the tendency of the crowd to mix through random agitation resulting in a pedestrian velocity represented by
$${\vec{u}}_{i} = \vec{V} ( ρ , ∇ h , {\vec{d}}_{i} ) - \frac{{D}_{i}}{{ρ}_{i}} ∇ {ρ}_{i} .$$

17. A non-transitory computer-readable medium storing instructions, the instructions comprising:
one or more instructions that, when executed by one or more processors, cause the one or more processors to:
receive
an initial configuration of personnel in a probability distribution,
subunit identity information including one or more orders that govern what the personnel are intended to achieve, and
environmental information through which the personnel are intended to travel;
generate, by the device, a predicted probability distribution of personnel based on
the initial configuration of personnel,
the subunit identity information, and
the environmental information; and
providing, by the device, information to a user interface related to the predicted future probability distribution of personnel.

18. The non-transitory computer-readable medium of claim 17, wherein the one or more orders include a desire of each subunit to reach a goal destination by specifying a direction of a crowd flow \vec{d}.

19. A method, comprising:
receiving, by a device,
an initial configuration of personnel in a probability distribution,
subunit identity information including one or more orders that govern what the personnel are intended to achieve, and
environmental information through which the personnel are intended to travel;
generating, by the device, a predicted probability distribution of personnel based on
the initial configuration of personnel,
the subunit identity information, and
the environmental information; and
providing, by the device, information to a user interface related to the predicted future probability distribution of personnel.

20. The method of claim 19, wherein the one or more orders include a desire of each subunit to reach a goal destination by specifying a direction of a crowd flow \vec{d}, and the crowd flow is characterized by a potential ϕᵢ(\vec{x}) that varies with position \vec{x} and type i of the of subunit, wherein the potential is minimum at the goal destination.
